(19) United States
(12) Patent Application Publication
(10) Pub. No.: US 2017/0330182 A1
(43) Pub. Date: Nov. 16, 2017

(54) SYSTEM FOR FACILITATING APPROVAL OF IN-FLIGHT PAYMENT ACCOUNT TRANSACTIONS

(71) Applicant: MasterCard International Incorporated, Purchase, NY (US)

(72) Inventor: Manoneet Kohli, O'Fallon, MO (US)

(21) Appl. No.: 15/150,884

(22) Filed: May 10, 2016

(51) Int. Cl. G06Q 20/40; G06Q 20/32; G06Q 50/30; H04L 29/08

(52) U.S. Cl. CPC G06Q 20/401; H04L 67/12; G06Q 20/3224; G06Q 50/30

(57) ABSTRACT

A method includes receiving a request for a payment account transaction. The method further includes determining whether the request has originated from a user device located within a transport aircraft at a time while the aircraft is in flight. The method also includes making an authorization decision with respect to the requested payment account transaction based at least in part on a result of the determining step.

### BACKGROUND

Payment accounts are in widespread use for both in-store and online purchase transactions. FIG. 1 is a block diagram of a previously proposed version of a payment system (generally indicated by reference numeral 100) as it may operate in connection with an online purchase transaction.

The system 100 includes an e-commerce server computer 102 that may be operated by or on behalf of an online merchant to permit online shopping transactions. For this purpose, as is well known, the e-commerce server computer 102 may host a shopping website, sometimes referred to as an “online store”. A customer 103 who operates a customer device 104 may access the shopping website by communicating over the Internet 105 with the e-commerce server computer 102. As is very well-known to those who are skilled in the art, the customer device 104 may be, for example, a personal computer or notebook computer that runs a browser program, a tablet computer or smartphone that runs a mobile browser and/or a suitable app, etc. As is very familiar to those who shop online, after the customer has selected one or more items of merchandise for purchase from the online store, he/she may elect to enter a checkout phase of the online purchase transaction. In some situations, during the checkout phase, the customer enters payment information, such as a payment account number, expiration date, security code, etc. into an online form. However, according to some proposals, the customer may be presented with an option to select use of the customer's digital wallet, which has been stored in a wallet service provider's computer 106. The digital wallet may contain data relating to several of the customer's payment accounts, and selecting the digital wallet option may result in the customer being presented with the opportunity to select one of those payment accounts for use in the current online purchase transaction. Upon the customer indicating selection of one of the accounts in the digital wallet, the wallet service provider 106 may make the corresponding data (again, payment account number, expiration date, security code, etc.) for the selected account available to the merchant's e-commerce server 102.

In connection with the online purchase transaction, the e-commerce server computer 102 may transmit a transaction authorization request message (sometimes simply referred to as an “authorization request”) to the merchant's acquirer financial institution (“acquirer” or “transaction acquirer”), indicated by reference numeral 110. Assuming that the digital wallet scenario described above had occurred, the authorization request may include the payment data provided from the wallet service provider 106 to the e-commerce server 102.

The acquirer 110 may route the authorization request via a payment network 112 to a server computer 114 operated by the issuer of the payment account that corresponds to the payment data included in the authorization request. Also, the authorization response generated by the issuer server computer 114 may be routed back to the acquirer 110 via the payment network 112. The acquirer 110 may confirm to the merchant (i.e., to the e-commerce server computer 102) that the transaction has been approved.

The payment network 112 may be, for example, the well-known Banknet® system operated by MasterCard International Incorporated, which is the assignee hereof.

The components of the system 100 as depicted in FIG. 1 are only those that are needed for processing a single transaction. Those who are skilled in the art will recognize that in the real world, online shopping and payment systems may process many purchase transactions (including simultaneous transactions) and may include a considerable number of payment account issuers and their computers, a considerable number of acquirers and their computers, and numerous merchants and their e-commerce servers. The system may also include a very large number of customers/online shoppers, who hold payment accounts that they use for their online shopping activities. In some environments there may also be a number of wallet service providers. It is also well known that elements of the system 100 (e.g., acquirers, the payment network, payment account issuers) may play similar roles in connection with in-store purchase transactions and in other types of transactions.

In online purchase transactions—as well as for in-store transactions—there is often a trade-off between requirements for security measures, such as user authentication, versus convenience for the customer. Moreover, customer convenience can be a critical factor in e-commerce businesses, since in many cases a customer who actually intends to purchase and has selected merchandise may abandon the transaction and navigate away from the online store website if the checkout phase entails more steps and/or more delays than the customer is willing to tolerate. The present inventor has recognized an opportunity in some situations to streamline approvals of online purchase transactions in a manner that also supports appropriate security measures.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional system that handles online purchase transactions.

FIG. 2 is a block diagram of a payment system according to some embodiments.

FIGS. 3 and 4 are block diagram representations of computers that may serve as components of the system shown in FIG. 2.

FIG. 5 is a block diagram representation of a user device that may play a role in the system of FIG. 2

FIGS. 6 and 7 are flow charts that illustrate aspects of the present disclosure.

### DETAILED DESCRIPTION

In general, and for the purpose of introducing concepts of embodiments of the present disclosure, approval of an online purchase transaction may be streamlined when it is detected that the purchase is being made by an individual who is currently a passenger on a passenger transport aircraft. In some embodiments, this situation may be detected by a payment account transaction authentication system based on an Internet Protocol (IP) address that is currently associated with the user device being employed for the transaction. The IP address information may be captured as part of the data relevant to the transaction and approval of the transaction. The authentication system may verify that the IP address indicates that the internet service provider that is currently providing service to the user device is one that provides in-flight internet service. Given that the user must pass through security checkpoints, purchase an airline ticket, purchase in-flight internet access, etc., in order to be served by the particular internet service, the authentication system may conclude that there is a low risk of fraud in transactions with an IP address for an in-flight internet service provider.

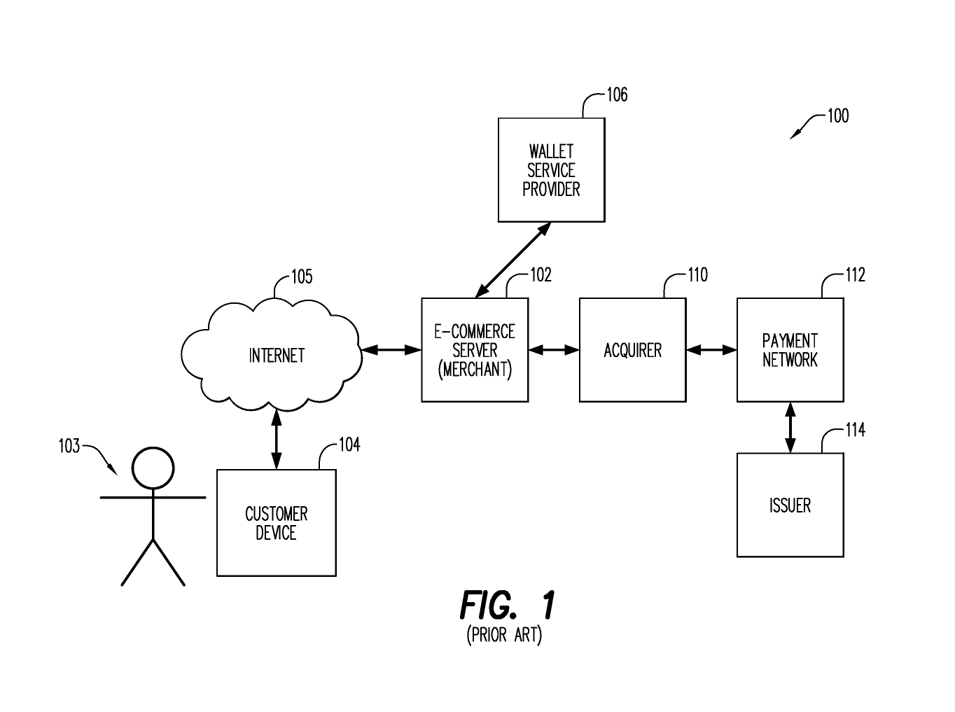

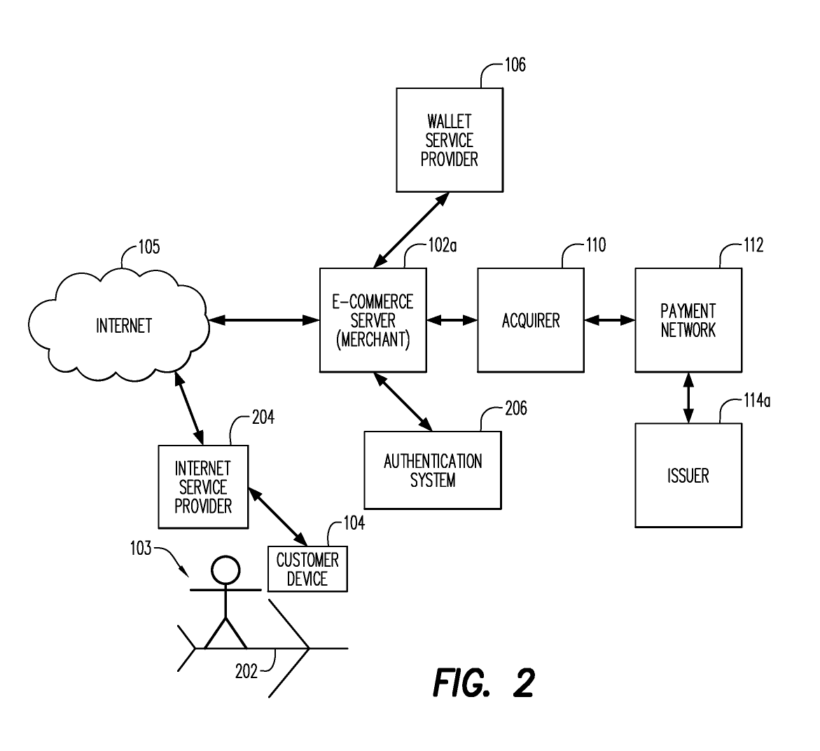

FIG. 2 is a block diagram of a payment system 200 provided according to some embodiments. The payment system 200 incorporates all of the elements referred to above in connection with FIG. 1. For example, elements/entities 104, 105, 106, 110 and 112 are carried over in the payment system 200 as depicted in FIG. 2 from the depiction of the payment system 100 shown in FIG. 1. Further, an element designated by the reference numeral 102a (e-commerce server) in FIG. 2 corresponds to the element designated by reference numeral 102 in FIG. 1. Also, an element designated by the reference numeral 114a (issuer server computer) in FIG. 2 corresponds to the element designated by reference numeral 114 in FIG. 1.

The user 103 is also again shown in FIG. 2, but in this instance is schematically portrayed as being an in-flight passenger on a commercial jet passenger transport aircraft 202. It is noted that the user 103 carries and is using the customer device 104 shown in FIG. 1. For reasons that will become clear from subsequent discussion, FIG. 2 also shows an internet service provider (ISP) 204, which provides internet access to passenger devices present on the aircraft 202. Accordingly, the ISP 204 is shown interconnecting the customer device 104 with the internet 105. (It will be understood that an ISP may also have been present in the arrangement of FIG. 1, though not shown in that drawing.)

According to aspects of the present disclosure, the payment system 200 also includes an authentication system 206. Details of the authentication system 202 will be discussed below. To briefly summarize some of the functionality of the authentication system 206, it may respond to requests from the e-commerce server 102a (and from numerous other such devices, not shown) to provide guidance and/or insight as to the degree of risk involved in a transaction that is currently being handled by the e-commerce server 102a. Such requests may generally be referred to as “authentication requests”, even though in some cases—as seen from discussion below—actual device identification or user authentication processes may not result from such requests. In other words, risk evaluation performed by the authentication system 206 may in some cases result in a finding that the risk involved in the current transaction is low, and that actual device or user authentication—and/or other security measures—may not be necessary or desirable. In some embodiments, the authentication system 206 may be operated by the operator of the payment network 112.

To discuss the subject matter of FIG. 2 more generally, it should be understood that in most cases, blocks labeled therein with names/descriptions of entities should also be understood to represent computer systems operated by or for such entities.

It should also be understood that, for at least some types of participants in the payment system 200, there may be a considerable or even a very large number of participants of those types in practical embodiments of the payment system 200. Moreover, one or more components of the payment system 200 may handle in-store purchase transactions and/or other types of transactions in addition to online purchase transactions.

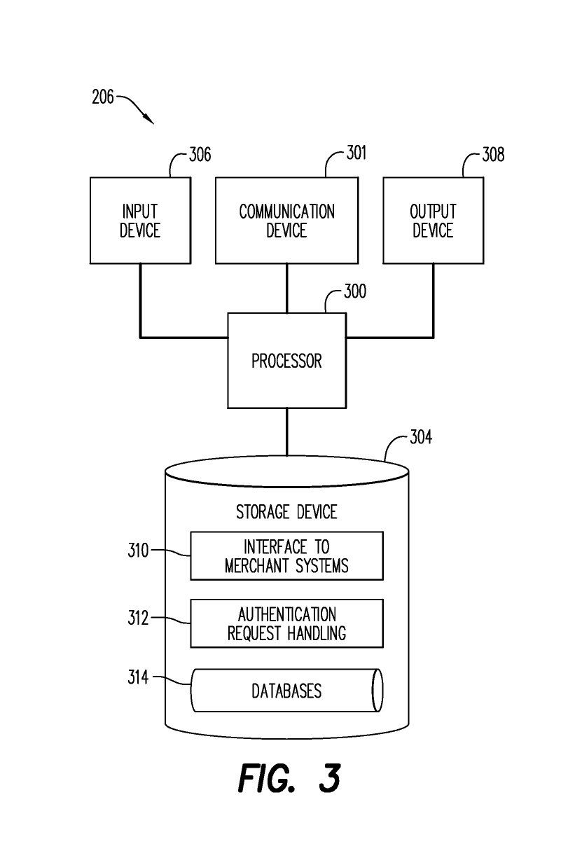

FIG. 3 is a block diagram representation of an embodiment of the authentication system 206.

In some embodiments, hardware aspects of the authentication system 206 may be constituted by typical server computer hardware, but may be controlled by software to cause it to function as described herein.

The authentication system 206 may include a processor 300 operatively coupled to a communication device 301, a storage device 304, an input device 306 and an output device 308. The communication device 301, the storage device 304, the input device 306 and the output device 308 may all be in communication with the processor 300.

The processor 300 may be constituted by one or more processors. The processor 300 may operate to execute processor-executable steps, contained in program instructions described below, so as to control the authentication system 206 to provide desired functionality.

Communication device 301 may be used to facilitate communication with, for example, other devices (such as e-commerce servers). For example, communication device 301 may comprise numerous communication ports (not separately shown), to allow the authentication system 206 to perform its roles in connection with numerous simultaneous online purchase transactions while interacting with numerous merchant devices.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the authentication system 206, executed by the processor 300 to cause the authentication system 206 to function as described herein.

The programs may include one or more conventional operating systems (not shown) that control the processor 300 so as to manage and coordinate activities and sharing of resources in the authentication system 206, and to serve as a host for application programs (described below) that run on the authentication system 206.

The programs stored in the storage device 304 may also include a software interface 310 that controls the processor 300 to support communication between the authentication system 206 and merchant e-commerce servers such as the computer represented by block 102a in FIG. 2.

Further, the storage device 304 may store an authentication request handling application program 312. The authentication request handling application program 312 may control the processor 300 such that the authentication system 206 provides functionality as described herein in connection with requests for guidance as to risks related to online purchase transactions.

The storage device 304 may also store, and the authentication system 206 may also execute, other programs, which are not shown. For example, such programs may include a reporting application, which may respond to requests from system administrators for reports on the activities performed by the authentication system 206. The other programs may also include, e.g., device drivers, database management programs, communications software, etc.

The storage device 304 may also store one or more databases 314 that may be required for operation of the authentication system 206.

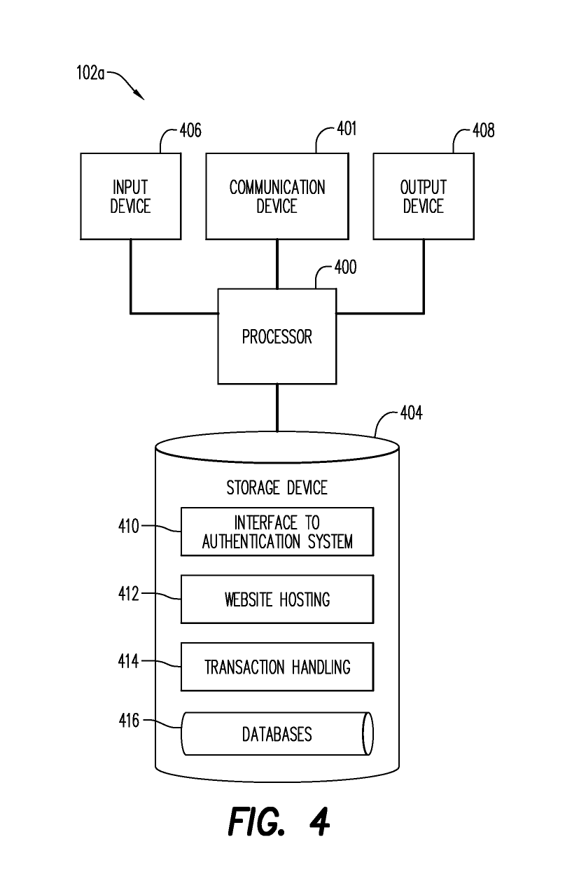

FIG. 4 is a block diagram of an embodiment of the e-commerce server 102a.

In its hardware architecture and components, the e-commerce server 102a may, for example, resemble the hardware architecture and components described above in connection with FIG. 3. However, the e-commerce server 102a may be programmed differently from the authentication system 206 so as to provide different functionality.

Returning again to the hardware aspects of the e-commerce server 102a, it may include a processor 400, a communication device 401, a storage device 404, an input device 406 and an output device 408. The communication device 401, the storage device 404, the input device 406 and the output device 408 may all be in communication with the processor 400.

The above descriptions of the hardware components shown in FIG. 3 may, in some embodiments, also be applicable to the like-named components shown in FIG. 4.

Storage device 404 stores one or more programs for controlling processor 400. The programs comprise program instructions (which may be referred to as computer readable program code means) that contain processor-executable process steps of the e-commerce server 102a, executed by the processor 400 to cause the e-commerce server 102a to function as described herein.

The programs may include one or more conventional operating systems (not shown) that control the processor 400 so as to manage and coordinate activities and sharing of resources in the e-commerce server 102a, and to serve as a host for application programs (described below) that run on the e-commerce server 102a.

The programs stored in the storage device 404 may include a software interface 410 that controls the processor 400 to support interactions between the e-commerce server 102a and the authentication system 206.

Further, the storage device 404 may store a website hosting program 412 that enables the e-commerce server 102a to make an online shopping website available to online shopping customers. In some embodiments, the website hosting program 412 may provide functionality such as is typically provided in connection with hosting of online shopping websites.

Still further, the storage device may store a transaction handling program 414. The transaction handling program 414 may program the processor 400 such that the e-commerce server 102a is enabled to handle online purchase transactions engaged in by visitors to the merchant's online shopping website. In some embodiments, the capabilities of the transaction handling program 414 may be such as are typically found in connection with handling of online purchase transactions, but with suitable modifications, as described below, to support additional functionality in accordance with aspects of the present disclosure.

The storage device 404 may also store one or more databases 416 that may be required for operation of the e-commerce server 102a.

Other computer components of the payment system 200 (FIG. 2) may also have the same type of hardware architecture and/or components as described above in connection with FIG. 3, and may be suitably programmed for the respective roles of those computer components.

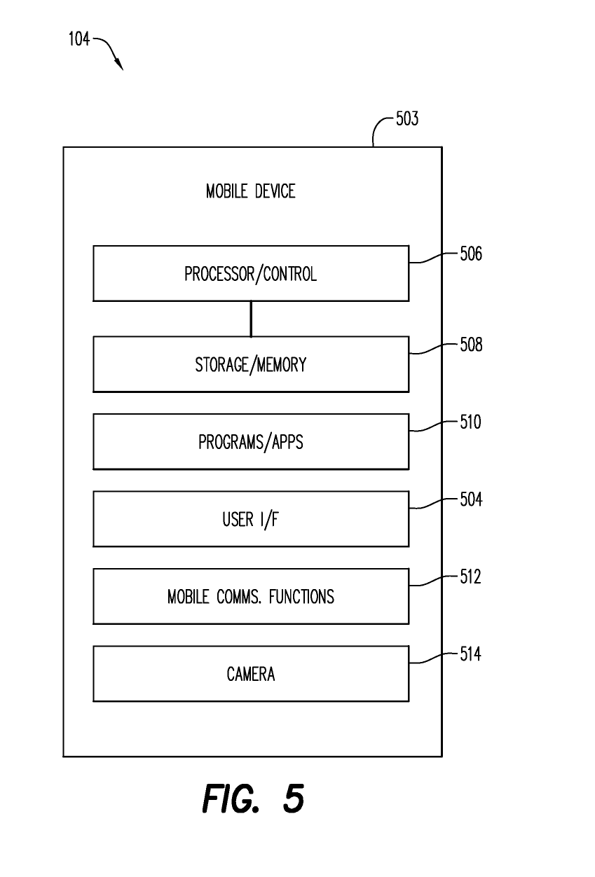

FIG. 5 is a block diagram of a typical embodiment of a customer device 104 as referred to above. In particular, it is assumed (though this assumption should not be taken to be limiting), that the customer device 104 is embodied as mobile device such as a smartphone or tablet computer. For the most part, the following description of the customer device 104 will assume that it is, in this particular case, a smartphone.

Continuing to refer to FIG. 5, the customer device 104 may include a housing 503. In many embodiments, the front of the housing 503 is predominantly constituted by a touchscreen (not separately shown), which is a key element of the user interface 504 of the customer device 104.

The customer device 104 further includes a mobile processor/control circuit 506, which is contained within the housing 503. Also included in the customer device 104 is a storage/memory device or devices (reference numeral 508). The storage/memory devices 508 are in communication with the processor/control circuit 506 and may contain program instructions to control the processor/control circuit 506 to manage and perform various functions of the customer device 104. As is well-known, a device such as customer device 104 may function as what is in effect a pocket-sized personal computer (assuming for example that the customer device is a smartphone), via programming with a number of application programs, or “apps”, as well as a mobile operating system (OS). (The apps are represented at block 510 in FIG. 5, and may, along with other programs, in practice be stored in block 508, to program the processor/control circuit 506.)

As is typical for mobile devices, the customer device 104 (in this embodiment) includes mobile and/or other communication functions as represented by block 512. The communication functions 512 may include voice and data communication via a mobile communication network (not shown) with which the customer device 104 is registered. It should also be understood that the communication capabilities included in the communication functions 512 may also include relatively short-range communication capabilities such as communication in accordance with the well-known WiFi standard. For example, WiFi communication may be engaged in to connect the customer device 104 to a communication system in the passenger cabin of the aircraft 202 (FIG. 2) for connection to the above-mentioned ISP 204. It will be appreciated that a suitable antenna and transceiver arrangement (both not separately shown) may be included in the customer device 104 to support WiFi communication.

Although also not separately shown in FIG. 5, it should be understood that the communication functions 512 may include hardware aspects such as a microphone, a speaker, an antenna, a transceiver circuit, etc., all supported in and/or on the housing 403, for communication via a mobile communication network.

Further, as is shown at block 514, and as is common in smartphones, the customer device 104 may also include a conventional digital camera. The camera 514 may be operable by the user 103 to capture images that may be stored in the customer device 104 and/or transmitted to another device from the customer device 104 via data communication.

From the foregoing discussion, it will be appreciated that the blocks depicted in FIG. 5 as components of the customer device 104 may in effect overlap with each other, and/or there may be functional connections among the blocks which are not explicitly shown in the drawing. It may also be assumed that, like a typical smartphone, the customer device 104 may include a rechargeable battery (not shown) that is contained within the housing 503 and that provides electrical power to the active components of the customer device 104.

It has been posited that the customer device 104 may be embodied as a smartphone, but this assumption is not intended to be limiting, as customer device 104 may alternatively, in at least some cases, be constituted by a tablet computer, a laptop computer, or another type of portable digital device.

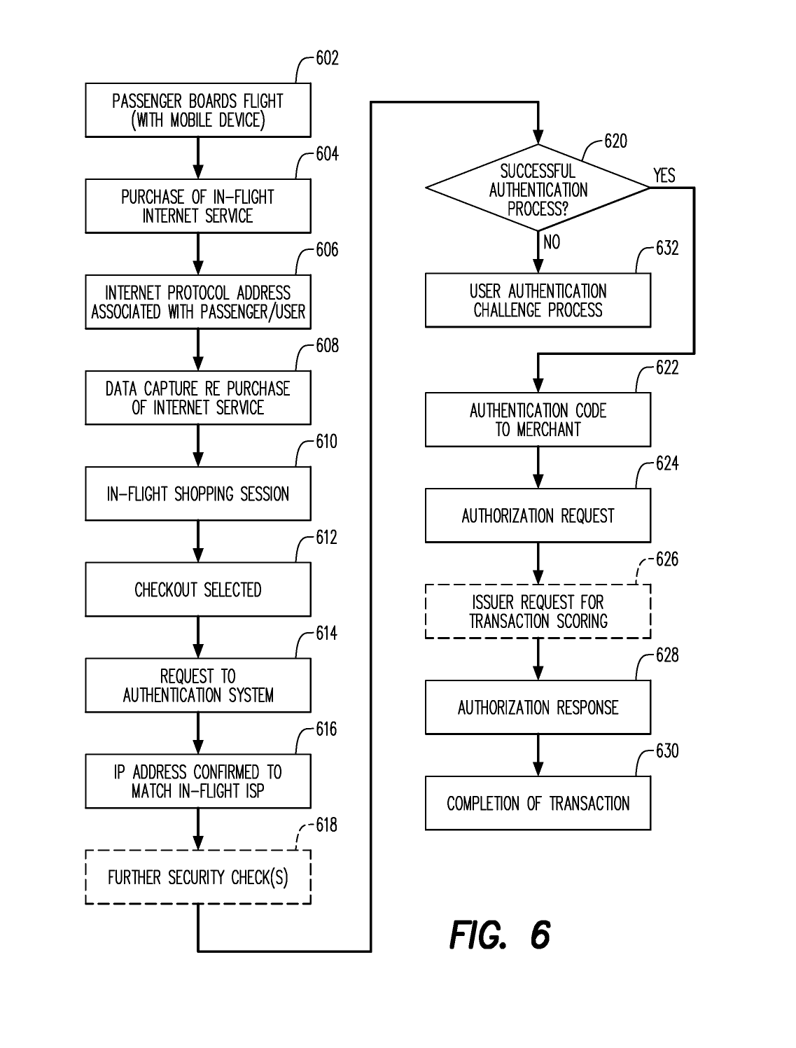

FIG. 6 is a flow chart that illustrates aspects of the present disclosure.

At block 602, the passenger user (reference numeral 103 in FIG. 2) boards the aircraft 202. The passenger is carrying the customer device 104 with him/her. The aircraft 202 is equipped to provide internet access via WiFi to WiFi-equipped devices in the passenger cabin (e.g., the customer device 104). For example, internet access may be an optional feature for which the passenger is required to pay an additional fee. Block 604 represents purchase of internet access by the passenger. This may occur after the passenger boards the aircraft 202 or may have been arranged via pre-purchase. (As with many process steps described herein, the order of steps 602 and 604 may vary from the order indicated in the drawing.)

At block 606 an IP address is associated with the customer device 104 (and thus to the user 103). The IP address may be used for communications with the customer device 104 via the internet 105. The associated IP address temporarily binds the customer device 104 to the ISP 204 (FIG. 2), which is the service provider that enables connection of devices in the passenger cabin to the internet 105.

It will be appreciated that the purchase of internet access by the user 103 may involve the user engaging in a payment account transaction to pay for the purchase. As part of the transaction, information about this service purchase, etc., may be logged (e.g., via communication from the ISP 204 to the authentication system 206 and/or to another computer or computers that serve as data repositories). Block 608 represents logging of the information collected in connection with the internet service purchase. The information collected/logged at 608 may include, for example, the identity of the flight (airline, flight no., date of flight, e.g.), the seat number that identifies the seat assigned to the passenger, a device identifier (e.g., ESN, MEID or IMEI) for the customer device 104, an identifier for the ISP 204, the payment account number used for the purchase (or other payment mechanism if a payment account was not used), etc.

At block 610, the passenger 103 engages in an online shopping session using the customer device 104 while the aircraft 202 is in flight. Access from the customer device 104 to the e-commerce server 102a occurs via the aircraft cabin WiFi system, via the internet service provided by the ISP 204 and via the internet 105. From the point of view of the passenger 103 (now an online customer of the merchant that operates the server 102a), the shopping experience may be the same as or similar to a typical online shopping session conducted at the passenger's home, for example. As is customary, the passenger/user/customer 103 selects one or more items of merchandise offered via the e-commerce server 102a, and then selects the checkout function (block 612) provided by the e-commerce server 102a. As part of the checkout process or otherwise during the online shopping session, the e-commerce server 102a notes and stores the IP address currently associated with the customer device 104. From previous discussion, it will be understood that, as part of checkout, the e-commerce server 102a also receives a payment account number that identifies the payment account that the user 103 wishes to use for the transaction.

At block 614, the e-commerce server 102a submits a request for guidance/authentication concerning the transaction to the authentication system 206. The request to the authentication system 206 may include information about the transaction, including the IP address associated with the customer device 104. At block 616, the authentication system 206 may confirm that the IP address associated with the customer device 104 matches (is provided through) the in-flight ISP 204. As noted above, because the environment of a commercial passenger flight is quite a secure, protected environment, the authentication system 206 may readily conclude that the transaction is relatively low risk in view of the identity of the ISP 204.

In some embodiments, the authentication system 206 may perform additional security checks (represented in phantom at block 618) with respect to the transaction. For example, the authentication system 206 may validate that the same payment account number to be used in the current transaction was also used to purchase the internet access for the flight. In addition or alternatively, the authentication system 206 may confirm that the user 103 (or the currently submitted payment account number) purchased an airline ticket that corresponds to the flight in which the user/passenger 103 is currently engaged.

Based at least in part on the result of step 616 and/or also on the additional security checks (block 618), the authentication system 206 may determine from the available information whether authentication can be deemed to have been successfully completed (decision block 620). If so, then block 622 may follow decision block 620. At block 622, the authentication system 206 may provide an account holder authentication code to the merchant (i.e., to the e-commerce server 102a) to indicate authentication was successfully completed. This code may be suitable for the merchant to submit with the transaction for routing to the account issuer 114a.

Block 624 in FIG. 6 represents the merchant generating a transaction authorization request for the current transaction, and routing of the authorization request via the acquirer 110 and the payment network 112 to the issuer server computer 114a. The authorization request may include that account holder authentication code issued by the authentication system 206 to the merchant. The authorization request may also identify relevant IP address information for the customer device 104.

In some embodiments, as indicated in phantom at block 626, the issuer may seek risk scoring from the authentication system 206 upon the issuer receiving the authorization request. In addition or alternatively, the issuer may seek validation of the IP address information.

Block 628 in FIG. 6 represents generation of a transaction authorization response by the issuer 114a, and routing of the authorization response to the merchant. At block 630 (assuming the authorization response is favorable), the transaction is successfully completed, and the user 103 is so informed via the customer device 104.

Referring again to decision block 620, if a negative determination is made at that decision block (i.e., ISP validation did not occur and/or other security checks do not sufficiently support a conclusion that the transaction is low risk), then block 632 may follow decision block 620. At block 632, for example, the authentication system 206 may engage in other authentication processes. Such other processes may include, for example, a user authentication process such as a biometric challenge or a PIN entry challenge presented to the user via the user device.

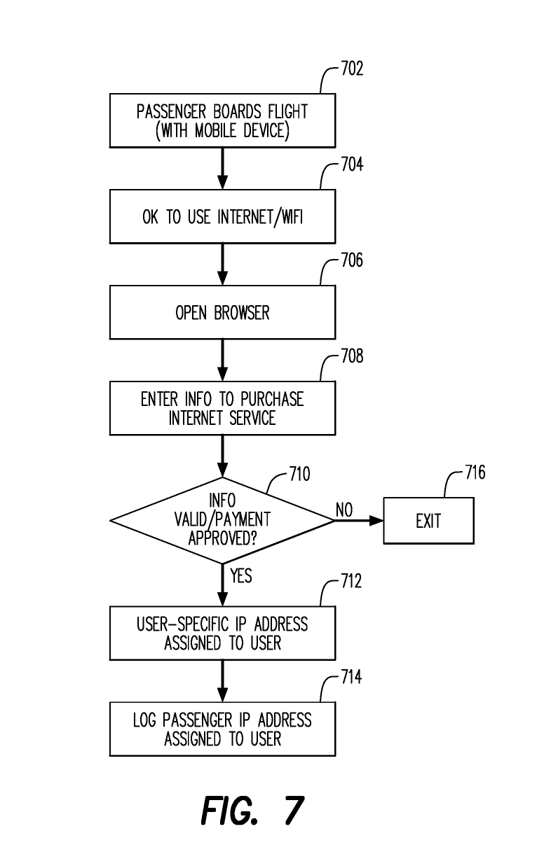

FIG. 7 is a flow chart that illustrates aspects of the present disclosure. The process illustrated in FIG. 7 may supplement or embody alternatives to the process described above in connection with FIG. 6.

At block 702 in FIG. 7, the user/passenger 103 boards the aircraft 202; while doing so the user/passenger is carrying the customer device 104 with him/her.

At block 704, the flight attendant announces (presumably, after the aircraft is aloft) that it is now permitted to employ computing devices to connect with the passenger cabin WiFi service, and that in-flight internet service is available for purchase.

At block 706, the passenger turns on the customer device 104 and opens the browser. The cabin WiFi system feeds a page for display on the customer device 104 to explain how to purchase WiFi service. At 708 the passenger enters required information for the purchase, including the passenger's name (as it appears on his/her payment system account), his/her seat number, boarding pass information, and the payment account number to indicate the payment account to be used to pay for the purchase of internet service. The boarding pass information may, for example, be input by the passenger capturing and uploading an image of the boarding pass using the camera component 514 (FIG. 5) of the customer device 104. Alternatively, if an electronic (“soft”) copy of the boarding pass is stored in the customer device 104, the passenger/user may simply be prompted to upload the electronic boarding pass information (and may do so). In some embodiments, simply the passenger's seat number, name and account number may be sufficient.

At decision block 710, the aircraft/airline system may determine whether the information (including the payment account number) is valid, the purchase transaction is authorized by the account issuer, etc. If all is in order, then block 712 may follow the decision block 710. At block 712, the ISP 204 may associate suitable IP address information with the user/passenger/customer device 104. In addition, all relevant information for the purchase of in-flight internet service may be logged (block 714). Depending on the type/version of the cabin communication equipment, and/or based on other factors, the IP address for the customer device 104 may be assigned in an IPv4 or IPv6 format, but in either case it may be desirable that all the information referred to in connection with block 708 be logged with the IP address associated with the customer device 104.

Referring again to decision block 710 in FIG. 7, if there is a problem with the information entered by the passenger or with the passenger's payment account, then the process may branch to an exit (block 716) from the decision block 710.

With a transaction processing approach as described herein, with reliance on an in-flight ISP-supplied IP address associated with the originating user device, it can be concluded with some confidence that there is a low risk of fraud for the transaction. Accordingly, acceptance and approval of the transaction can be streamlined to provide maximum convenience for the user and to promote in-flight online shopping and use of payment accounts.

Moreover, in the unlikely event that there is a problem with a purchase transaction conducted from an in-flight IP address, very detailed information is likely to be available regarding the purchaser from the airline, the ISP or other sources, so that legal or other recourse may be readily available to the merchant and/or the issuer.

In embodiments of processes as described above, a user/passenger was described as having purchased in-cabin WiFi service. However, steps other than purchase may take place in other embodiments to permit the user to access the in-cabin WiFi service. For example, WiFi service may be offered without charge, and with only user registration/input of data required. For example, scanning the user's boarding pass with the customer device 104 may suffice to complete registration. In some embodiments, some or all required information may be input by the user manually interacting with a keyboard or virtual keyboard on the customer device 104. The information collected may be one or more of the types of information referred to above in connection with block 608 of FIG. 6. The registration process may also involve obtaining the user's consent to terms and conditions applicable to the in-cabin WiFi service.

As another alternative to requiring purchase of the WiFi service, the user may be permitted to submit a voucher that grants access to the in-cabin WiFi service. For example, the voucher may be associated with the user's assigned seat; for example, submission of the voucher may include scanning a barcode from the user's boarding pass or scanning the boarding pass as a whole. An electronic voucher that has been stored previously in the customer device 104 is another possible alternative, and may be submitted electronically. Consent to terms and conditions of service may also be required in addition to submitting the voucher. Collection of information (again, e.g., as per block 608) may occur.

As used herein and in the appended claims, the term “making an authorization decision” refers to any determination related to whether or not a payment account transaction is to go forward, and includes responding to an inquiry from a merchant or account issuer as to a degree of risk associated with a payment account transaction.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving a request for a payment account transaction;
determining whether the request has originated from a user device located within a transport aircraft at a time while the aircraft is in flight, said request initiated at said time; and
making an authorization decision with respect to the requested payment account transaction based at least in part on a result of the determining step.

2. The method of claim 1, wherein said result of the determining step is based at least in part on an Internet Protocol address associated with the user device.

3. The method of claim 2, wherein said Internet Protocol address is associated with an internet service provider that provides in-flight internet service.

4. The method of claim 1, wherein said result of the determining step is based at least in part on a record indicating that a user of the user device purchased internet service for use on said transport aircraft.

5. The method of claim 1, wherein said result of the determining step is based at least in part on a record indicating that a payment account associated with the requested payment account transaction was used to purchase internet service for use on said transport aircraft.

6. The method of claim 1, wherein said result of the determining step is based at least in part on a record indicating that the user device was used to purchase internet service for use on said transport aircraft.

7. The method of claim 1, wherein said result of the determining step is based at least in part on a record that indicates that a user of the user device boarded the transport aircraft.

8. The method of claim 1, wherein said result of the determining step is based at least in part on a record that indicates that a user of the user device bought an airline ticket for being a passenger on the transport aircraft.

9. The method of claim 1, wherein said result of the determining step is based at least in part on a record that associates the user device with a seat on the transport aircraft.

10. The method of claim 1, wherein said result of the determining step is based at least in part on a record that associates the user device with a specific seat on the transport aircraft.

11. The method of claim 1, wherein the record is an image of an airline boarding pass.

12. An apparatus comprising:
a processor; and
a memory in communication with the processor, the memory storing program instructions, the processor operative with the program instructions to perform functions as follows:
receiving a request for a payment account transaction;
determining whether the request has originated from a user device located within a transport aircraft at a time while the aircraft is in flight, said request initiated at said time; and
making an authorization decision with respect to the requested payment account transaction based at least in part on a result of the determining step.

13. The apparatus of claim 12, wherein said result of the determining step is based at least in part on an Internet Protocol address associated with the user device.

14. The apparatus of claim 13, wherein said Internet Protocol address is associated with an internet service provider that provides in-flight internet service.

15. The apparatus of claim 12, wherein said result of the determining step is based at least in part on a record indicating that a user of the user device purchased internet service for use on said transport aircraft.

16. The apparatus of claim 12, wherein said result of the determining step is based at least in part on a record indicating that a payment account associated with the requested payment account transaction was used to purchase internet service for use on said transport aircraft.

17. The apparatus of claim 12, wherein said result of the determining step is based at least in part on a record indicating that the user device was used to purchase internet service for use on said transport aircraft.

18. A non-transitory storage medium storing program instructions, the program instructions for programming a processor to perform functions as follows:
receiving a request for a payment account transaction;
determining whether the request has originated from a user device located within a transport aircraft at a time while the aircraft is in flight, said request initiated at said time; and
making an authorization decision with respect to the requested payment account transaction based at least in part on a result of the determining step.

19. The medium of claim 18, wherein said result of the determining step is based at least in part on an Internet Protocol address associated with the user device.

20. The medium of claim 19, wherein said Internet Protocol address is associated with an internet service provider that provides in-flight internet service.
